(19) United States
(12) Patent Application Publication
(10) Pub. No.: US 2010/0224572 A1
(43) Pub. Date: Sep. 9, 2010

(54) Water Treatment Device and Method

(76) Inventor: Marianna Cooley, Houston, TX (US)

Correspondence Address: Nielsen IP Law LLC, 1177 West Loop South, Suite 1600, Houston, TX, 77027, US

(21) Appl. No.: 12/280,132

(22) PCT Filed: Feb. 21, 2007
(86) PCT No.: PCT/US2007/062514

§ 371 Date: Dec. 31, 2008

Related U.S. Application Data
(60) Provisional application No. 60/775,091, filed on Feb. 21, 2006.

(51) Int. Cl. C02F 1/68; A01N 59/20; A01P 1/00

(52) U.S. Cl. 210/764; 210/263; 210/242.1; 210/198.1; 424/618

(57) ABSTRACT

A waterline treatment system for treating and preventing biofilms in a dental unit includes a plurality of noncontiguous silver and copper pieces in a ratio between about 8:3 to 10:1, in order to maintain less than 200 colony forming units per milliliter in the water. The waterline treatment device may include a housing, optionally equipped with a flotation mechanism. The water treatment device may be packaged in a kit along with a pre-treatment liquid component that includes colloidal silver.

### RELATED APPLICATIONS

This application claims priority to U.S. provisional application 60/775,091 filed Feb. 21, 2006 and is incorporated by reference herein in its entirety.

### FIELD OF THE INVENTION

The present invention relates to the prevention and treatment of biofilm in water treatment systems.

### BACKGROUND OF THE INVENTION

Biofilms are populations of microorganisms surrounded by a mucous or slime layer. Biofilms can form in various environments and have the ability to grow on many surfaces including in water supply lines. Merritt et al., “Bacterial Biofilm and Dentistry”, CDA Journal, 29(5): 355-360 (2001). Microorganisms in a biofilm survive better and exhibit stronger resistance to the environment than do cells that are not in a biofilm. Id. The mucous or slime layer of the biofilm protects the growth of the microorganisms. Biofilms have proven resistant to antibiotics, chlorhexidine and household bleach because of an inability to penetrate the protective mucous layer of the biofilm. These mutually protective mechanisms are caused by “layering” where outside microbes protect deeper layers of microbes.

The American Dental Association (ADA) standard for water quality requires that water delivered to patients during nonsurgical dental procedures consistently contain no more than 200 colony forming units per milliliter (CFU/ml) of aerobic mesophilic heterotrophic bacteria at any point in time in the unfiltered output of the dental unit. See, ADA Statement on Dental Unit Waterlines, July 2004, available at www.ada.org/prof/resources/positions/statements/lines.asp. Dental unit waterlines have been shown to contain a wide variety and number of microorganisms including bacteria, fungi and protozoans. The microorganisms form biofilms on the interior surfaces of the waterline tubing. Biofilms serve as a reservoir to amplify the number of free-floating, planktonic forms of microorganisms in the water provided by the waterlines. Id. Dental unit waterlines provide an ideal environment for biofilms to form due to laminar flow, low flow rate, low volume of use, small diameter tubes, high surface/volume ratio, long lengths of tubing, room temperature or warmer, plastic tubing and dental water aerosols.

Common methods of reducing bacteria in dental unit waterlines are daily flushing of the waterlines with chlorohexidine or household bleach. Another method is use of large in-line sanitation cartridges consisting of silver ions. Yet another method of treatment is flushing ozonated water through the waterlines periodically. Although some of these methods may be effective treating bacterial colonies there are several drawbacks to these sanitizing agents. In addition to difficulties in penetrating the protective mucous layer chlorohexidine is considered toxic when inhaled or ingested according to the manufacturers safety data sheet (MSDS), and chlorohydrocarbons are generally considered carcinogenic. Similarly, ozone is quite toxic to the user and it reacts with various rubber parts, such as gaskets and hosing, making them brittle and shortening their useful lifespan. While silver ion on its own is toxic to bacteria, albeit less toxic than many other metals, over time bacterial resistance to silver ion results in gradually reduced effectiveness.

There exists, therefore, a continuing need for a non-toxic treatment for dental lines to aid in achieving the ADA standard.

### BRIEF SUMMARY OF THE INVENTION

The present invention provides a waterline treatment device and method for preventing and treating biofilms. A water treatment system of the present invention includes a plurality of noncontiguous pieces of silver and copper metals, colloids or salts thereof. The waterline treatment device is positioned in a water reservoir of a dental unit and aids in reducing the amount of bacteria in the water to less than 200 colony forming units per milliliter. The ratio of silver to copper generally is between about 8:3 to about 10:1.

The present invention also relates to a method of treating a water supply of a dental unit comprising a) providing a shock treatment with a silver colloid solution and b) passing the water of a dental unit reservoir through a waterline treatment device. The waterline treatment device includes a plurality of noncontiguous pieces of silver and copper contained within a device having a flotation mechanism wherein the amount of bacteria is maintained at less than 200 colony forming units per milliliter.

Additionally, the present invention provides a kit which includes a waterline treatment device and a pre-treatment liquid component.

The foregoing has outlined rather broadly the features and technical advantages of a number of embodiments of the present invention in order that the detailed description of the present invention that follows may be better understood. Additional features and advantages of the invention will be described hereinafter.

### BRIEF DESCRIPTION OF THE DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 is a perspective view showing a waterline treatment device.

FIG. 2 is another perspective view of the waterline treatment device.

FIG. 3 is yet another perspective view of the waterline treatment device.

FIG. 4 is yet a further perspective view of the waterline treatment device.

FIG. 5 is still another perspective view of the waterline treatment device.

FIG. 6 is a cross-sectional view of the waterline treatment device.

FIG. 7 shows an end cap on the waterline treatment device.

FIG. 8 shows another end cap on the waterline treatment device.

FIG. 9 shows a dental unit equipped with a water reservoir.

### DETAILED DESCRIPTION OF THE INVENTION

Microorganisms can be any organism of microscopic size, including but not limited to, bacteria, viruses, algae, fungi and protozoa. Microorganisms can be prokaryotic or eukaryotic and unicellular or multicellular. Examples of microorganisms include Escherichia coli, Saccharomyces cerevisiae and rhinoviruses. Bacteria are prokaryotes with most bacteria being unicellular. Examples of bacteria include Escherichia coli, Streptococcus pneumoniae and Staphylococcus aureus. Planktonic (free-floating) bacteria slough off of the slime layer periodically as more bacteria continue to grow within the biofilm.

Copper and silver (generally in their cationic form) are known for their antimicrobial and antifungal properties. For example, silver and copper cations are capable of penetrating biofilm mucous layers and adhering to bacterial cell walls. The biocidal activity of copper and silver is due to several factors including (i) depression of nutrient uptake, (ii) inhibition of cell division, (iii) interference of proton transfer, and (iv) bonding to DNA increasing the stability of the double helix.

The present invention provides a waterline treatment device that treats water contaminated with biofilm. This device includes, but is not limited to, non-toxic (to humans) levels of antimicrobial/antifungal copper and silver which may be painted onto pieces, plated onto cathodes or used in pure metallic form. Pieces of copper and silver and/or salts (i.e. metallic salts) thereof may be used. The copper and silver may be coated on a surface. For example, copper and silver salts may be applied by dipping or painting salts onto pieces of substrate and as phosphate coatings. Copper and silver may also be applied to any irregular or porous surface including but not limited to ceramic, bone carbon and polystyrene foam. The pieces containing copper and silver can be of any shape, and can include pieces made of silver and separate pieces made of copper as well as pieces that contain both copper and silver. The copper formulation may be 100% cuprous oxide or cupric oxide or cuprous iodide in dilute 7% phosphoric acid. Alternatively, the copper formulation may comprise 50% cupric oxide and 50% ferric oxide in dilute phosphoric acid. The copper formulation may include to cupric oxide, pure copper, cuprous iodide, copper phosphates, cuprous oxide, and colloidal copper. The silver formulation may be comprised of 100% silver nitrate or 100% silver chloride in dilute 7% phosphoric acid. The silver formulation may include but is not limited to silver nitrate, silver phosphate, pure silver, silver chloride, and colloidal silver. The pieces are then dried.

The pieces containing copper and silver may be placed in any sized housing in order to rid the environment of biofilm. The ions will enter solution and create an antimicrobial effect.

Copper and silver ions can be delivered into solution by various methods to be effective. The metal cations sanitize the water, removing harmful levels of bacteria. Copper and silver cations may be slowly released into water and dispersed through the water via ionic dispersion. Copper has the ability to pierce the protective outer membrane of a cell and disrupt enzyme balance. Silver is effective because of its ability to interfere with DNA production and accelerating the death phase. These synergistic biocidal effects of copper and silver makes this combination more effective against biofilms compared to the use of either cation alone. The ratio of silver to copper is between about 8:3 to about 10:1. More specifically, the ratio of silver to copper is generally about 9:2. The greater toxicity of copper to microbial/fungal pathogens is reflected in the need for less copper in the waterline treatment device. The copper and silver pieces can be spherical metal balls with electroplated silver and copper. Specifically, there can be 9 such spheres with electroplated silver and 2 such spheres with electroplated copper arranged within the housing of the waterline treatment device.

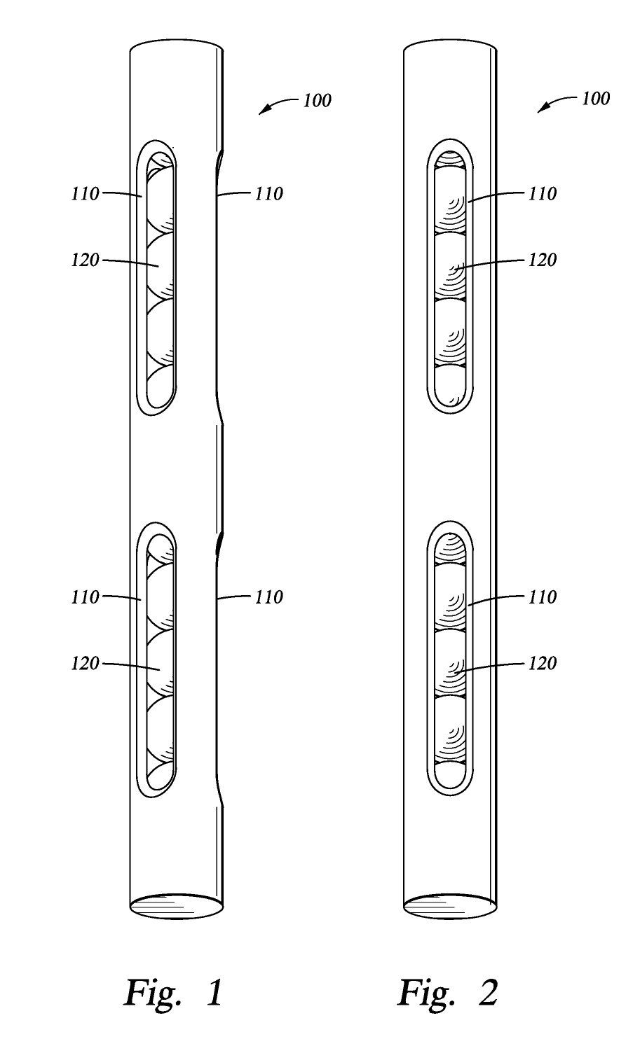

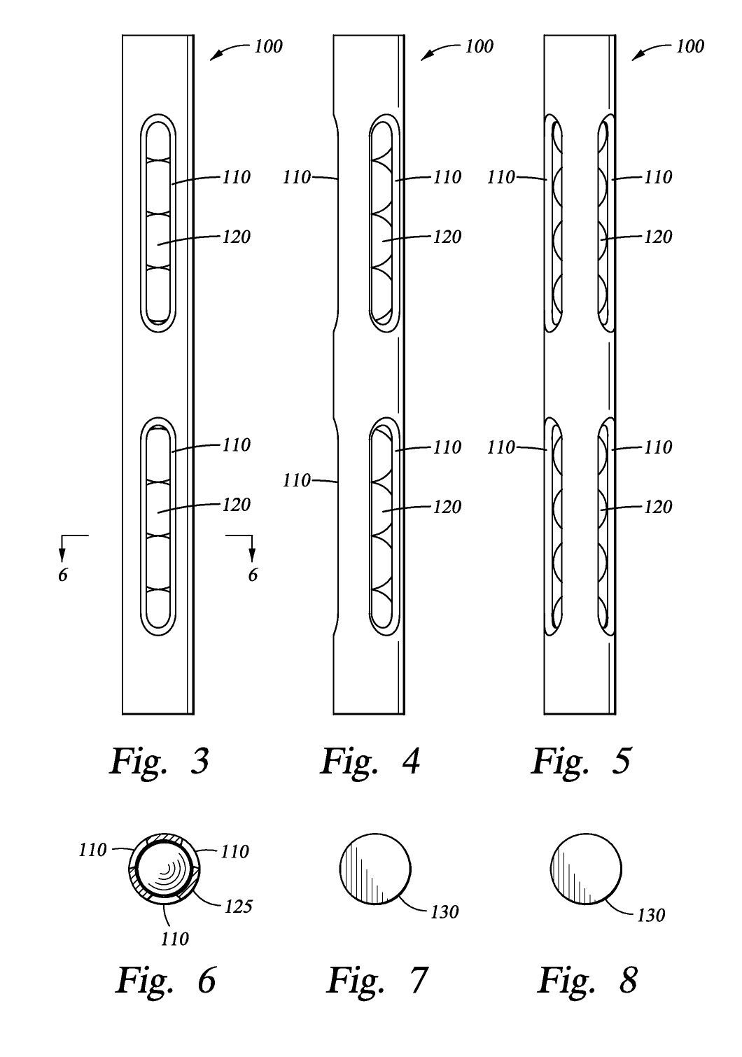

Copper and silver containing pieces may be combined in a housing which has one or more polystyrene foam inserts causing the housing to float in the water. A PVC housing with at least one opening may be utilized to allow water to diffuse into direct contact with the treated pieces of copper and silver. FIGS. 1-6 show different views for one exemplary design for a waterline treatment device 100 of the present invention. Waterline device 100 is equipped with several openings 110 which allow water to diffuse into and out of the housing and allowing contact with silver and copper electroplated spheres 120. FIG. 7 shows a cross-section 125 of device 100 with the arrangement of openings 110 in the device. As shown in FIGS. 7 and 8 the two ends of device 100 may be equipped with end caps 130 which do not allow the silver and copper pieces to fall out of the housing. Although end caps 130 are shown as solid caps, they may be optionally fitted with holes to aid in water diffusion through waterline treatment device 100. Different sizes of housings and different numbers of pieces may be used to meet the need of the body of water to be treated. The hardness (mineral content) of the water, and the volume are major factors in governing the effective size needed to destroy the biofilm. Larger amounts of water to be purified will require proportionally larger housings and numbers of pieces of silver and copper. The holes or vents allowing water to enter the housing can be of various sizes and shapes as well.

Any mechanism of flotation may be utilized such as chambers or styrofoam, for example. The housing can be made from material which floats. Flotation keeps the device in contact with the flow of the water in the tank, reservoir or body of water. Flotation, however, is not required to maintain effective biofilm kill rates. The device can be used to treat drinking water, water used for sterilization of instruments, water tanks, swimming pools, hot tubs, canteen, waterbottles, animal water feeders or troughs, any form of water storage (cistern) or delivery tank. Using the waterline treatment device described herein the amount of bacteria in the water may be maintained at less than 200 colony forming units per milliliter (CFU/mL).

The present invention also provides a water treatment system which includes a waterline treatment device and a pre-treatment liquid component. The pre-treatment liquid component is an aqueous colloidal silver solution. The function of the pre-treatment liquid is a shock treatment for initial killing of very large bacterial colonies, for example.

The amount of silver colloid should be an amount effective to display antibacterial and antifungal activity, yet low enough to be non-toxic to users of the purified water. Silver toxicity is usually in the form of argyria, which manifests as a bluish hue to the skin. For non-toxic loads, the silver colloid may be present between about 0.2% to about 0.5% by weight. One such commercially available solution of silver colloid is 0.36% (available from Cooley and Cooley Ltd., Houston, Tex.).

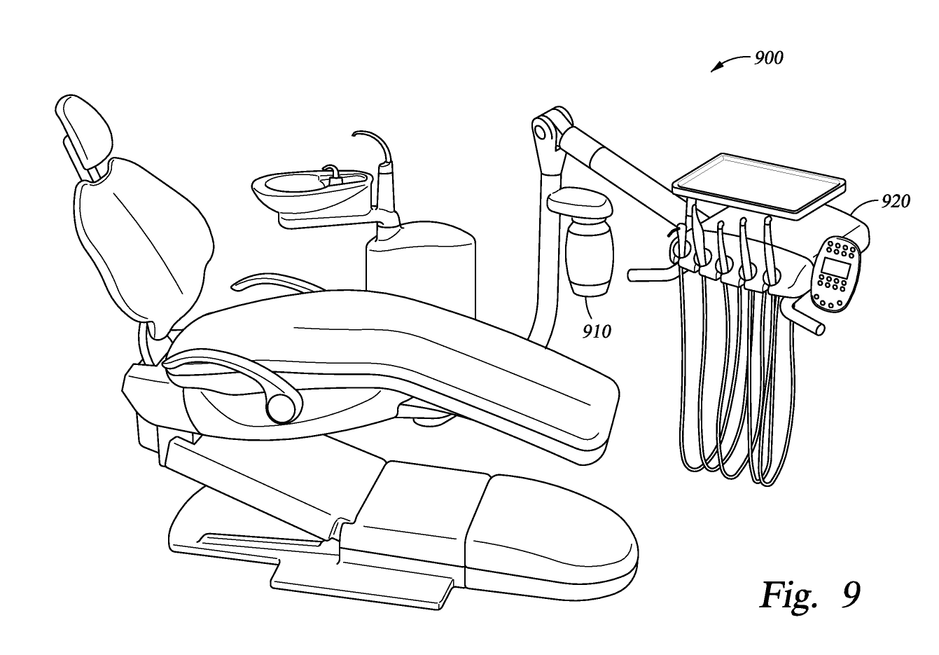

In treating dental unit waterline (DUWL) contamination, a treatment of colloidal silver with a range greater than 10 ppm may be used to prepare the container and water exit lines. The biofilm build-up may then be flushed out of the waterline tubing. A dental unit may provide water, vacuum and compressed air. As shown in FIG. 9, a dental unit waterline 900 is equipped with a bottle 910 used as the reservoir to hold the necessary water for the dental unit's components 920, such as high speed handpiece, water syringe, and ultrasonic unit. The dental unit provides water via a dental unit waterline which many times is connected directly with municipal water lines. Since 1995, all new dental unit manufacturers in the U.S. have been required by the American Dental Association to install a separate water reservoir on each dental unit sold. All units built prior to 1995 must be retrofitted with an easy to install dental unit water reservoir. The device for use in dental units is a relatively small “drop-in” cartridge that does not require daily flushing of waterlines and the expense of chemical purchases. The device does not require special plumbing or electricity to activate the copper and silver pieces within the housing. The device has an activation capacity for a minimum of 365 days and a maximum of 730 days.

### EXAMPLES

The following examples are provided to more fully illustrate some of the embodiments of the present invention. It should be appreciated by those of skill in the art that the techniques disclosed in the examples which follow represent techniques discovered by the inventors to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

### Example 1

### Preparation of Device

Ceramic pieces are electroplated with either silver or copper metallic salts. When dried, these pieces are placed into a housing containing multiple holes to allow water to contact the pieces. The housing contains polystyrene foam to enable the device to float. The device was placed into the reservoir of a dental waterline unit.

### Example 2

### Use of Device

The device may be placed in a tank of a water. The cartridge should be allowed to float for 3 hours prior to use of the water to kill fecal coliform bacteria. The cartridge will continue to kill bacteria for 365 days after placement in the tank.

### Example 3

### Waterline Sanitization Procedures Administered for Test Samples Submitted to Sterilization Assurance Service on Aug. 4, 2005

At the end of the day, ¼ cup of bleach in ½ liter of water was placed in the dental unit water bottle. The bleach solution was flushed through all of the lines until the bottle was empty. The lines were allowed to sit dry overnight. In the morning, the bottles were filled and flushed with distilled water. Table 1 shows the colony forming units (CFU) per milliliter for tools used in the dental office. The DUWL testing results column indicates whether the values pass the ADA goal of water delivered to patients during nonsurgical dental procedure having no more than 500 CFU/ml of aerobic mesophilic heterotrophic bacteria.

TABLE 1

| | CFU/ml | | | DUWL Testing |
|---|---|---|---|---|
| Location | Bacteria | Fungus | Total | Results |
| Room 1 - | 210 | 0 | 210 | Pass |
| Cavitron | | | | |
| Room 1 -A/W | 53,600 | 0 | 53,600 | Fail |
| syringe | | | | |
| Room 2 -A/W | 210 | 20 | 230 | Pass |
| syringe | | | | |
| Room 3 - | 2940 | 100 | 3040 | Fail |
| Cavitron | | | | |
| Room 3 -A/W | 240,000 | 500 | 240,500 | Fail |
| syringe | | | | |
| Blank | 0 | 0 | 0 | Pass |

### Example 4

### Waterline Sanitization Procedures Administered for Test Samples Submitted to Sterilization Assurance Service on Sep. 1, 2005

The device was placed in the dental unit water bottle without pretreatment with 30 ml of silver hydrosol and submerged at all times. No flotation mechanism was attached to this device. Table 2 shows the colony forming units (CFU) per milliliter for tools used in the dental office. The DUWL testing results column indicates whether the values pass the ADA goal of water delivered to patients during nonsurgical dental procedure having no more than 500 CFU/ml of aerobic mesophilic heterotrophic bacteria.

TABLE 2

| | CFU/ml | | | DUWL Testing |
|---|---|---|---|---|
| Location | Bacteria | Fungus | Total | Results |
| Room 1 - | 480 | 0 | 480 | Pass |
| Cavitron | | | | |
| Room 1 -A/W | 980 | 0 | 980 | Fail |
| syringe | | | | |
| Room 2 -A/W | 370 | 0 | 370 | Pass |
| syringe | | | | |
| Room 3 - | 300 | 0 | 300 | Pass |
| Cavitron | | | | |
| Room 3 -A/W | 290 | 0 | 290 | Pass |
| syringe | | | | |
| Blank | 0 | 0 | 0 | Pass |

### Example 5

### Waterline Sanitization Procedures Administered for Test Samples Submitted to Sterilization Assurance Service on Oct. 3, 2005

Two ounces of the pre-treatment liquid of 10 ppm of silver hydrosol (colloidal silver) was placed in 1 liter of tap water. The mixture was flushed through all of the lines. The device was placed in the dental unit water bottle and submerged at all times. Table 3 shows the colony forming units (CFU) per milliliter for tools used in the dental office. The DUWL testing results column indicates whether the values pass the ADA goal of water delivered to patients during nonsurgical dental procedure having no more than 500 CFU/ml of aerobic mesophilic heterotrophic bacteria.

TABLE 3

| | CFU/ml | | | DUWL Testing |
|---|---|---|---|---|
| Location | Bacteria | Fungus | Total | Results |
| Room 1 - | 10 | 0 | 10 | Pass |
| Cavitron | | | | |
| Room 1 -A/W | 130 | 0 | 130 | Pass |
| syringe | | | | |
| Room 2 -A/W | 40 | 10 | 50 | Pass |
| syringe | | | | |
| Room 3 - | 30 | 0 | 30 | Pass |
| Cavitron | | | | |
| Room 3 -A/W | 10 | 0 | 10 | Pass |
| syringe | | | | |

### Example 6

### Procedures for Shock Treatment with Colloidal Silver

A typical stock solution of pre-treatment liquid (Cooley and Cooley Ltd., Houston, Tex.) has a non-toxic concentration of colloidal silver (silver hydrosol) of 0.36% by weight in aqueous solution.

To treat bacteria coming through a handpiece, air/water syringe and/or ultrasonic equipment with bacterial colonies too numerous to count (CFU/mL), a 30 mL bottle of the typical stock solution of pre-treatment liquid is added into the dental unit reservoir (typically 0.7 to 2 liters) to purge the bacterial infestation. The concentrate is purged for 20 seconds and allowed to remain in the lines overnight before a final purge of the lines the next morning.

To treat bacteria below 100,000 CFU/mL in the lines a dose of 10 mL of the stock pre-treatment liquid is added to 1 gallon of distilled water. This enhanced water is added into the water reservoir with the waterline cartridge. 4 one gallon aliquots are prepared in the same manner and each gallon purged through the dental equipment. After this procedure the bacterial level will be below 500/CFU/mL, the recommended level by the CDC, OSHA, and the ADA.

To treat bacteria buildup in suction lines 2-3 drops of the stock pre-treatment liquid are added to 30 mL of water. This diluted solution is suctioned down the tubing.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above and below described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

It is therefore, contemplated that the claims will cover any such modifications or embodiments that fall within the true scope of the invention.

All publications and patent applications mentioned in this specification are indicative of the levels of those skilled in the art to which this invention pertains. All publications and patent applications are herein incorporated by reference to the same extent as if each individual publication or patent application was specifically and individually indicated to be incorporated by reference.

What is claimed is:

1. A waterline treatment system for treating and preventing biofilms in water of a dental unit comprising:
a plurality of noncontiguous silver and copper pieces, wherein the ratio of silver to copper is between about 8:3 to about 10:1 and the water contains less than 200 colony forming units per milliliter.

2. The waterline treatment system of claim 1, wherein the ratio of silver to copper is about 9:2.

3. The waterline treatment system of claim 1 further comprising a pre-treatment liquid component comprising silver colloid.

4. The waterline treatment system of claim 3, wherein the silver colloid is between about 0.2% to about 0.5% by weight.

5. The waterline treatment system of claim 4, wherein the silver colloid is between about 0.36% by weight.

6. A waterline treatment device for destroying biofilms in water comprising:
(a) a housing having a plurality of openings; and
(b) a plurality of noncontiguous silver and copper pieces positioned within said housing;
wherein the ratio of silver to copper is a range from about 8:3 to about 10:1; and
wherein said device is positioned in the water reservoir of a dental unit and water diffuses into and out of said housing causing the amount of bacteria in the water to be maintained at less than 200 colony forming units per milliliter.

7. The waterline treatment device of claim 6 further comprising a flotation means positioned within the housing.

8. The waterline treatment device of claim 6, wherein the ratio of silver to copper is about 9:2.

9. The waterline treatment device of claim 6, wherein the plurality of noncontiguous silver and copper pieces are spheres with electroplated silver and copper.

10. A method of treating a water supply for a dental unit comprising:
providing a shock treatment of the water supply with a pre-treatment liquid component; and
allowing diffusion of water in a dental unit reservoir through a waterline treatment device of claim 1.

11. The method of claim 10, wherein the pre-treatment liquid component comprises a silver colloid.

12. The method of claim 11, wherein the silver colloid is between about 0.2% to about 0.5% by weight.

13. The method of claim 12, wherein the silver colloid is between about 0.36% by weight.

14. A system for treating a water supply for a dental unit comprising:
a waterline treatment device of claim 1; and
a pre-treatment liquid component used in conjunction with said waterline treatment device, wherein said liquid component comprises silver colloid.

15. The system of claim 14, wherein the silver colloid is between about 0.2% to about 0.5% by weight.

16. The method of claim 15, wherein the silver colloid is about 0.36% by weight.

17. A kit comprising:
a waterline treatment device of claim 1; and
a pre-treatment liquid component for shock treating a water supply comprising silver colloid in about 0.36% by weight.

18. The kit of claim 12, wherein the pre-treatment liquid component is packaged separately from said waterline treatment device.
